(19) United States
(12) Patent Application Publication
(10) Pub. No.: US 2006/0022942 A1
(43) Pub. Date: Feb. 2, 2006

(54) Control method for operating a computer cursor instinctively and the apparatus thereof

(76) Inventor: Po-Chi Lin, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/903,916

(22) Filed: Jul. 30, 2004

(51) Int. Cl. G09G 5/08

(52) U.S. Cl. 345/157

(57) ABSTRACT

A control method for operating a computer cursor instinctively and the apparatus thereof are disclosed. Thus, a user can manipulate displacement, selection and execution function of the cursor of the display of the computer easily and conveniently, thereby facilitating the user operating the cursor of the display by his two hands.

### BACKGROUND OF THE INVENTION

1. Field of the Invention

The present invention relates to a control method, and more particularly to a control method for operating a computer cursor instinctively and the apparatus thereof.

2. Description of the Related Art

A conventional track mouse for a computer comprises a pad or a contact face, and a track ball slidable on the pad to control movement of a cursor of a display of the computer. However, the conventional track mouse needs a contact face so that movement of the mouse is limited by space and distance of the working place, thereby causing inconvenience to a user in operating the mouse to control movement of the cursor. In addition, dust or dirt is easily accumulated onto the surface of the track ball to decrease the sensitivity of the mouse, so that the mouse cannot control movement of the cursor exactly and sensitively during a long-term utilization.

A conventional optical mouse for a computer employs the optical reflection or refraction principle to replace the conventional track ball so that dust or dirt cannot be accumulated onto the surface of the mouse. However, the conventional optical mouse stills needs a contact face so that movement of the mouse is limited by space and distance of the working place, thereby causing inconvenience to a user in operating the mouse to control movement of the cursor.

### SUMMARY OF THE INVENTION

In accordance with one embodiment of the present invention, there is provided a control method for operating a computer cursor instinctively, comprising:

a user holding a pointer which emits infrared rays or visible light spots, a capture device capturing local images of the pointer and optical signals of the infrared rays or visible light spots emitted by the pointer, a detection software using an image processing technology to filter background noises and to analyze positions of the infrared rays or visible light spots, wherein when the positions of the infrared rays or visible light spots are changed, the local images of the pointer and the optical signals the infrared rays or visible light spots emitted by the pointer are captured and transmitted by the capture device to the detection software which filters the background noises and calculates a relative displacement of the infrared rays or visible light spots to convert the relative displacement into a displacement signal which is used for a cursor of a display and is identified by a common computer so as to control displacement of the cursor of the display; and

the pointer emitting a light source of modulated infrared rays or visible light spots to form a modulated signal which is mixed with another modulated signal, the capture device capturing local images of the pointer and the modulated infrared rays or visible light spots emitted by the pointer, the detection software using the image processing technology to filter background noises and to analyze positions of the modulated infrared rays or visible light spots having at least two different frequencies to respectively convert the positions of the modulated infrared rays or visible light spots into displacement signals, selection signals or execution signals which are used for the cursor of the display and are identified by the common computer so as to control the cursor of the display to move, select an object or execute functions of a software.

In accordance with another embodiment of the present invention, there is provided an apparatus for performing the control method, comprising a pointer, a capture device, and a detection software, wherein:

the pointer includes a shank, an emitter mounted on a first end of the shank to emit infrared rays, visible light or wireless waves, at least one function key mounted on a surface of the shank, and a circuit module mounted in the shank and electrically connected to the emitter and the function key;

the capture device is a video camera, an electric wave transceiver or any device that can capture images, the capture device captures the images from the pointer and the optical signals or electric wave signals emitted by the pointer, and inputs the captured signals into the computer in a transmission manner; and

the detection software is loaded into a system application program interface of the computer and includes an image capture program, an image processing program, an image storage, a signal analysis program, a tracing displacement signal program, and a light spot positioning program.

The primary objective of the present invention is to provide a control method for operating a computer cursor instinctively and the apparatus thereof, wherein the user can manipulate displacement, selection and execution function of the cursor of the display of the computer easily and conveniently, thereby facilitating the user operating the cursor of the display by his two hands.

Another objective of the present invention is to provide a control method for operating a computer cursor instinctively and the apparatus thereof, wherein the pointer is held by the user to control functions the cursor of the display without needing aid of any contact face (the conventional track mouse needs a contact face) to prevent the cursor of the display from being limited by space or distance, thereby facilitating the user operating the cursor of the display.

A further objective of the present invention is to provide a control method for operating a computer cursor instinctively and the apparatus thereof, wherein the cursor of the display is operated exactly and sensitively in comparison with the conventional track mouse, thereby facilitating the user operating the cursor of the display.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an apparatus for operating a computer cursor instinctively in accordance with the preferred embodiment of the present invention;

FIG. 2 is a perspective view of a pointer of the apparatus as shown in FIG. 1;

FIG. 3 is a circuit layout of a circuit module of the apparatus as shown in FIG. 1;

FIG. 4 is a perspective view of a capture device of the apparatus as shown in FIG. 1; and

FIG. 5 is a block diagram of a detection software of the apparatus as shown in FIG. 1.

### DETAILED DESCRIPTION OF THE INVENTION

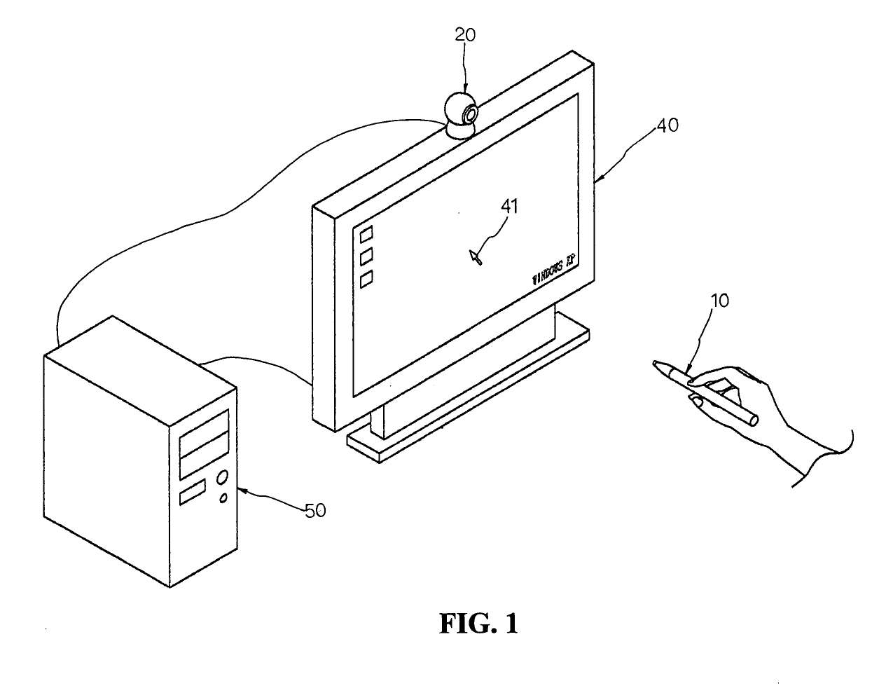

Referring to the drawings and initially to FIG. 1, a control method for operating a computer cursor instinctively in accordance with the preferred embodiment of the present invention comprises the following steps.

Fist of all, a user holds a pointer 10 which emits infrared rays or visible light spots. A capture device 20 captures local images of the pointer 10 and optical signals of the infrared rays or visible light spots emitted by the pointer 10. A detection software 30 uses an image processing technology to filter background noises and to analyze positions of the infrared rays or visible light spots. When the pointer 10 is moved by the user, the positions of the infrared rays or visible light spots are displaced and changed, while the local images of the pointer 10 and the optical signals the infrared rays or visible light spots emitted by the pointer 10 are captured and transmitted by the capture device 20 to the detection software 30 which filters the background noises and calculates a relative displacement of the infrared rays or visible light spots. The relative displacement is converted into a displacement signal which is used for a cursor 41 of a display 40 and is identified by a common computer 50 so as to control displacement of the cursor 41 of the display 40.

Subsequently, the user operates the pointer 10 to emit a light source of modulated infrared rays or visible light spots to form a modulated signal which is mixed with another modulated signal. The capture device 20 captures local images of the pointer 10 and the modulated infrared rays or visible light spots emitted by the pointer 10. The detection software 30 uses the image processing technology to filter background noises and to analyze positions of the modulated infrared rays or visible light spots having at least two different frequencies. The positions of the modulated infrared rays or visible light spots are respectively converted into displacement signals, selection signals or execution signals which are used for the cursor 41 of the display 40 and are identified by the common computer 50 so as to control the cursor 41 of the display 40 to move, select an object or execute functions of a software.

Referring to FIGS. 1-5, an apparatus for performing the control method to operate a computer cursor instinctively in accordance with the preferred embodiment of the present invention comprises a pointer 10, a capture device 20, and a detection software 30. The detection software 30 is loaded into a system corresponding to the computer 50, and has a connecting transmission function to perform the control method and to control functions of displacement, selection and execution of the cursor 41 of the display 40 so as to control displacement of the cursor 41 of the display 40 and to execute a soft program indicated by the display 40.

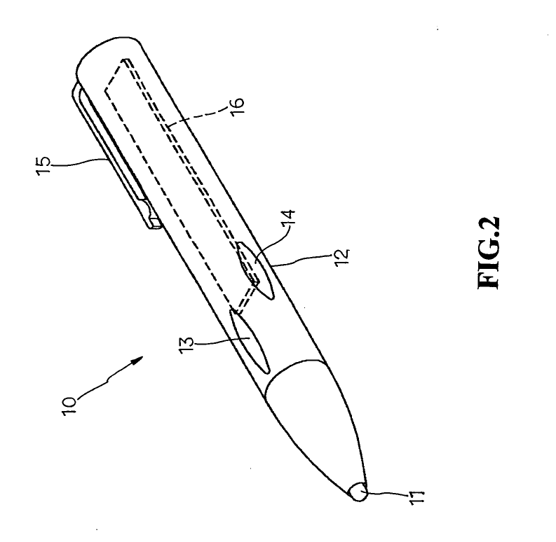

Referring to FIG. 2, the pointer 10 is a pen-type device using infrared rays, visible light or wireless waves. The pointer 10 includes a shank 12, an emitter 11 mounted on a first end of the shank 12 to emit the infrared rays, visible light or wireless waves, a plurality of function keys 13 and 14 mounted on a surface of the shank 12, a clip 15 mounted on a second end of the shank 12 to facilitate a user carrying the pointer 10, and a circuit module 16 mounted in the shank 12 and electrically connected to the emitter 11 and the function keys 13 and 14.

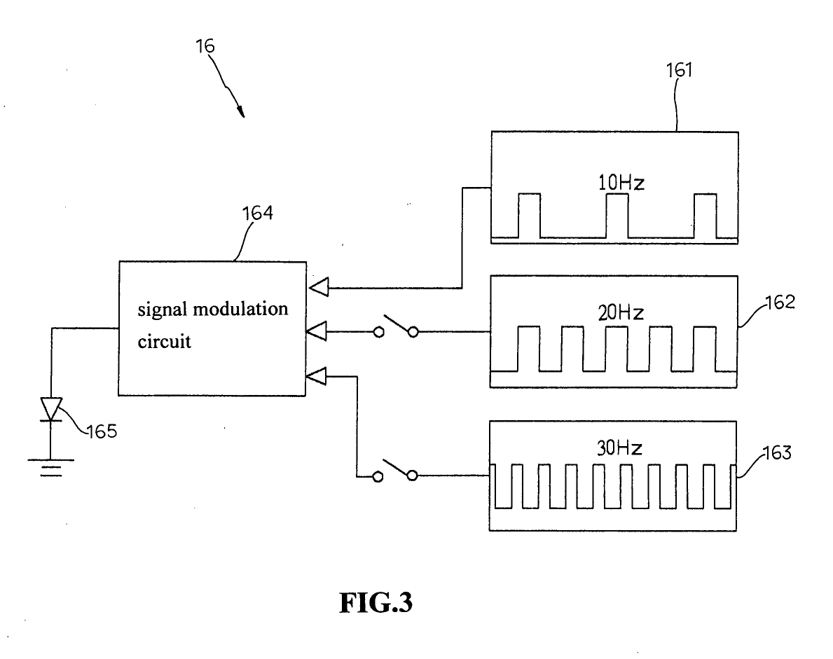

Referring to FIG. 3, the circuit module 16 of the pointer 10 includes three signal generators 161, 162 and 163 having three different frequencies, a signal modulation circuit 164, and a signal output member 165. Preferably, the signal output member 165 is an output device of infrared rays, visible light or wireless waves.

When the pointer 10 is started, the signal generator 161 of the circuit module 16 produces a first signal having a frequency of 10 Hz which is transmitted through the signal modulation circuit 164 to the signal output member 165 and is emitted outward by the emitter 11.

When the user presses the function key 13 of the pointer 10, the signal generator 162 of the circuit module 16 is driven to produce a second signal having a frequency of 20 Hz. At this time, the second signal having a frequency of 20 Hz is mixed with the first signal having a frequency of 10 Hz by the signal modulation circuit 164, and the mixed signal is output from the signal output member 165 and emitted outward by the emitter 11.

When the user presses the function key 14 of the pointer 10, the signal generator 162 of the circuit module 16 is driven to produce a third signal having a frequency of 30 Hz. At this time, the third signal having a frequency of 30 Hz is mixed with the first signal having a frequency of 10 Hz by the signal modulation circuit 164, and the mixed signal is output from the signal output member 165 and emitted outward by the emitter 11. In such a manner, the circuit module 16 of the pointer 10 outputs a signal having a single frequency or a mixed frequency.

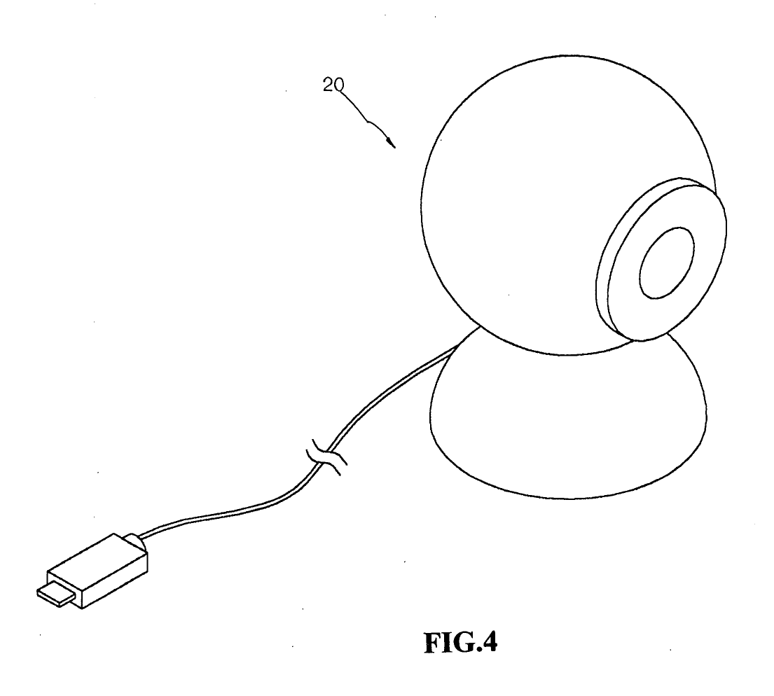

Referring to FIG. 4, the capture device 20 is a video camera, an electric wave transceiver or any device that can capture images. The capture device 20 captures the images from the pointer 10 and the optical signals or electric wave signals emitted by the pointer 10, and inputs the captured signals into the computer 50 in a transmission manner.

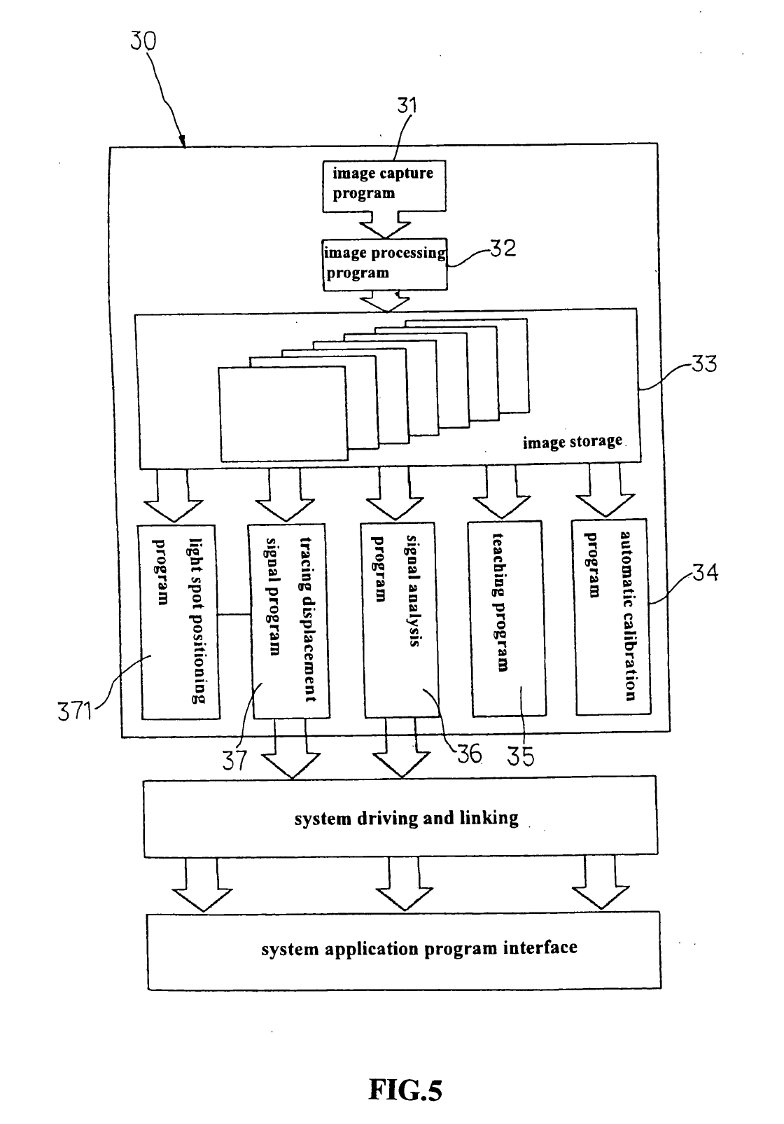

Referring to FIG. 5, the detection software 30 is loaded in a system interface corresponding to the computer 50 to connect and link a system application program interface of the computer 50. The detection software 30 includes an image capture program 31, an image processing program 32, an image storage 33, an automatic calibration program 34, a teaching program 35, a signal analysis program 36, a tracing displacement signal program 37, and a light spot positioning program 371.

Referring to FIGS. 1-5, after the detection software 30 loaded in the computer 50 is started, the user holds the pointer 10 which emits a signal having a frequency of 10 Hz. Then, the capture device 20 captures the local images and the light spots of the signal having a frequency of 10 Hz and transmits the signal to the computer 50. Then, the image capture program 31 of the detection software 30 captures the picture produced by the capture device 20, and the image processing program 32 of the detection software 30 processes the images and stores the processed images in the image storage 33. At the same time, the light spot positioning program 371 searches for the pixels in the picture to find light spots that contain the signal having a frequency of 10 Hz so as to perform a light spot positioning procedure. After the light spot positioning procedure is accomplished, the tracing displacement signal program 37 of the detection software 30 is driven to trace the relative displacement positions of the light spots and to convert the signal of the relative displacement positions of the light spots into a signal that is corresponding to a displacement function of a common mouse and is identified by the system application program interface of the computer 50 so as to control displacement of the cursor 41 of the display 40.

When the user presses the function key 13 or 14 of the pointer 10, the pointer 10 emits a signal having a frequency of 20 Hz or 30 Hz. Then, the capture device 20 captures the local images and the light spots of the signal having a frequency of 20 Hz or 30 Hz and transmits the signal to the computer 50. Then, the image capture program 31 of the detection software 30 captures the picture produced by the capture device 20, and the image processing program 32 of the detection software 30 processes the images and stores the processed images in the image storage 33. At the same time, the signal analysis program 36 of the detection software 30 filters the light spots to judge if the light spots contain a modulated signal having a frequency of 20 Hz or 30 Hz. When the signal analysis program 36 of the detection software 30 detects the modulated signal, the signal analysis program 36 of the detection software 30 converts the modulated signal into a signal that is corresponding to a selection or execution function of the common mouse and is identified by the system application program interface of the computer 50 so as to control the selection or execution function of the cursor 41 of the display 40.

In such a manner, the user can manipulate displacement, selection and execution function of the cursor 41 of the display 40 of the computer 50 easily and conveniently, thereby facilitating the user operating the cursor 41 of the display 40 by his two hands.

In addition, after the detection software 30 loaded in the computer 50, the teaching program 35 of the detection software 30 teaches the user how to use the pointer 10, to position the borders, to adjust the velocity of the push buttons, and to preset the parameters, such as the displacement, selection or execution function of the cursor 41 of the display 40. In addition, the automatic calibration program 34 of the detection software 30 performs an image analysis and calibrates the relative displacement positions of the light spots automatically to enhance the precision of the cursor 41 of the display 40.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A control method for operating a computer cursor instinctively, comprising:
a user holding a pointer which emits infrared rays or visible light spots, a capture device capturing local images of the pointer and optical signals of the infrared rays or visible light spots emitted by the pointer, a detection software using an image processing technology to filter background noises and to analyze positions of the infrared rays or visible light spots, wherein when the positions of the infrared rays or visible light spots are changed, the local images of the pointer and the optical signals the infrared rays or visible light spots emitted by the pointer are captured and transmitted by the capture device to the detection software which filters the background noises and calculates a relative displacement of the infrared rays or visible light spots to convert the relative displacement into a displacement signal which is used for a cursor of a display and is identified by a common computer so as to control displacement of the cursor of the display; and
the pointer emitting a light source of modulated infrared rays or visible light spots to form a modulated signal which is mixed with another modulated signal, the capture device capturing local images of the pointer and the modulated infrared rays or visible light spots emitted by the pointer, the detection software using the image processing technology to filter background noises and to analyze positions of the modulated infrared rays or visible light spots having at least two different frequencies to respectively convert the positions of the modulated infrared rays or visible light spots into displacement signals, selection signals or execution signals which are used for the cursor of the display and are identified by the common computer so as to control the cursor of the display to move, select an object or execute functions of a software.

2. The control method in accordance with claim 1, wherein the pointer emits a wireless wave frequency.

3. An apparatus for performing the control method in accordance with claim 1, comprising a pointer, a capture device, and a detection software, wherein:
the pointer includes a shank, an emitter mounted on a first end of the shank to emit infrared rays, visible light or wireless waves, at least one function key mounted on a surface of the shank, and a circuit module mounted in the shank and electrically connected to the emitter and the function key;
the capture device is a video camera, an electric wave transceiver or any device that can capture images, the capture device captures the images from the pointer and the optical signals or electric wave signals emitted by the pointer, and inputs the captured signals into the computer in a transmission manner; and
the detection software is loaded into a system application program interface of the computer and includes an image capture program, an image processing program, an image storage, a signal analysis program, a tracing displacement signal program, and a light spot positioning program.

4. The apparatus in accordance with claim 3, wherein the pointer further includes a clip mounted on a second end of the shank.

5. The apparatus in accordance with claim 3, wherein the circuit module of the pointer includes three signal generators having three different frequencies, a signal modulation circuit, and a signal output member, and the signal output member is an output device of infrared rays, visible light or wireless waves.

6. The apparatus in accordance with claim 3, wherein the detection software further includes an automatic calibration program and a teaching program.
